(19) United States
(12) Patent Application Publication
(10) Pub. No.: US 2005/0245294 A1
(43) Pub. Date: Nov. 3, 2005

(54) Dual axis hinge for handheld device

(75) Inventors: Sheel A. Gupte, Buffalo Grove, IL (US); James Fuhrman, Pleasant Prairie, WI (US)

Correspondence Address: GREER, BURNS & CRAIN, 300 S WACKER DR, 25TH FLOOR, CHICAGO, IL, 60606, US

(73) Assignee: Amphenol-T&M Antennas.

(21) Appl. No.: 11/094,332

(22) Filed: Mar. 30, 2005

Related U.S. Application Data
(60) Provisional application No. 60/557,527, filed on Mar. 30, 2004.
(60) Provisional application No. 60/557,823, filed on Mar. 30, 2004.

(51) Int. Cl. H04M 1/00

(52) U.S. Cl. 455/575.1; 455/575.3

(57) ABSTRACT

The invention provides a dual axis hinge for handheld devices. A preferred embodiment is a self-contained hinge that provides controlled rotation about two axes, e.g., perpendicular x- and y-axes. Controlled rotation about an x-axis includes fully open and closed biased positions, and also preferably provides self-open and/or self-close assistance when predetermined rotational points about the x-axis are reached. Controlled rotation about a y-axis provides a bias position, e.g., 0°. Additionally, in the preferred embodiment both negative and positive rotation about the y-axis are permitted, and hard stops are defined at limits of negative and positive rotation. In a preferred embodiment hinge, a unitary main body supports x-axis and y-axis rotational control sub-assemblies. The main body is preferably substantially hollow, with bores that provide a path through which wiring, e.g., flex circuit, may be routed through. Embodiments of the invention also provide hinges with low part counts, e.g. dual axis hinges with 8-10 parts.

### PRIORITY CLAIM AND APPLICATION REFERENCE

This application claims priority under 35 U.S.C. §119 from prior provisional application Ser. No. 60/557,527, filed Mar. 30, 2004, and from prior provisional application Ser. No. 60/557,823, filed Mar. 30, 2004.

### BACKGROUND OF THE INVENTION

A field of the invention is handheld devices, e.g., personal digital assistants and handsets. The invention particularly concerns handheld devices that include a hinged connection, e.g., flip style or clam shell devices.

Flip-style or clam shell devices are very popular because they form a convenient shape, and the devices have proven to be aesthetically pleasing to a large segment of the consumer market. When closed, the devices provide a small device footprint, making the storage of the device in a pocket, on a clip, in a holder, in a briefcase, in a purse, or a drawer, etc., very convenient. While the description of the devices as “flip-style” and “clam shell” may be used interchangeably, for purposes of illustration only, the device will be herein described as a “flip-style” device.

A hinge used to form a hinged connection in a handheld device, such as a flip-style device, is in a very demanding environment. Operational cycles are high frequency, meaning that users of flip-style and other hinged handheld devices open and close the device frequently. In the example of a flip-style cellular handset, a user commonly opens and closes the device with each use of the device. The hinge in a flip-style device must also provide a smooth and controlled operation, and should be biased to remain in the respective open and closed positions. There is considerable interest, however, in keeping the hinge simple and as inexpensive as possible. The handheld device market is extremely competitive, and component expenses must be kept as low as possible.

While there is a premium placed on reducing the overall size of the flip style device, there is also a need to house circuitry and other electronics within the flip style device, and as such, efficient use of the available space is desirable. However, often times, one of either the flip part or the main part of the flip style device, typically the flip part, is relegated to a relatively simple design having minimal circuitry, such as where the flip part is a dedicated keyboard or a display. One of the reasons for the simplicity of one of the typical flip part compared to a main part of a handheld device is the barrier to wired connections between the flip part and the main part presented by the hinged connection. Therefore, from a manufacturing perspective, there is a generally missed opportunity provided by the flip part to include additional electronics therein.

More specifically, the springs, cams, follower, can, device interface, locking clips, and other components of a typical hinge present a physical barrier to wiring. Wiring must be routed around the hinge and placed in a manner such that the open and close operation does not pull on the wiring. The limited number of connections available has often limited the electronic communication channels between the system electronics, e.g., processor and memories, of a main part (where they are typically housed) and the electronics in the flip part, e.g., displays, keyboards. An unattractive alternative is including another system, e.g., a processor and memory, in the flip part. The increased cost and inefficiency of that alternative is clear, and yet there is pressure to do so as the functionality of the flip style devices continues to drive the creation of increasingly complex handheld devices, which now perform functions such as capturing images and videos.

Efforts have therefore been made to route both discrete wires and flex connections circuitously around hinge components. However, the hinge is relatively small and only a limited number of cables or wires can be accommodated. A further problem is the difficulty of predicting and testing the life of a highly flexed cable assembly, which is repeatedly twisted in this manner. These approaches limit the number and type of electronics that can be placed in the flip part. Another approach is to use contact sets instead of wires. Contacts still are limited in area by the hinge, though. In addition, contacts may suffer performance problems because alignment becomes an issue. If contacts on a main part become misaligned with a flip part, for example, an adequate electric connection may not be obtained.

Other issues related to hinged connections and handheld devices include part count and assembly issues. Low part counts are desirable for manufacturing efficiencies and to reduce costs. It is also desirable that a hinge for a hinged handheld device such as a flip-style handset be self-contained and pre-assembled. This aids in the manufacturing of the handset, and also permits manufacture and assembly of components of the handset and the hinge to be conducted at separate locations and, for example, by separate vendors.

Yet another issue of concern in hinged connections of handheld devices arises when it is desirable for the flip part and main part to move relative to one another into the fully open and fully closed positions about one axis, and also rotate relative to one another about another axis such that a front portion of the flip part opposes a front portion of the main part. For example, where the flip part is a display, it may be desirable for the flip part to rotate a predetermined amount, relative to the main part, so that an operator could allow others to view the screen. Conventional hinge systems accommodate movements that include opening and closing about a main axis and rotating, to some limit of rotation, about a second axis typically perpendicular to the first axis. Conventional dual axis hinge systems typically create additional physical obstacles to circuitry and electronics, and complicate the assembly and movement of the flip device. In addition, conventional dual axis hinge systems typically limit rotation about the second axis to a single direction.

### SUMMARY OF THE INVENTION

The invention provides a dual axis hinge for handheld devices. A preferred embodiment is a self-contained hinge that provides controlled rotation about two axes, e.g., perpendicular x- and y-axes. Controlled rotation about an x-axis includes fully open and closed biased positions, and also preferably provides self-open and/or self-close assistance when predetermined rotational points about the x-axis are reached. Controlled rotation about a y-axis provides a bias position, e.g., 0°. Additionally, in the preferred embodiment both negative and positive rotation about the y-axis are permitted, and hard stops are defined at limits of negative and positive rotation.

In a preferred embodiment hinge, a unitary main body supports x-axis and y-axis rotational control sub-assemblies. The main body is preferably substantially hollow, with bores that provide a path through which wiring, e.g., flex circuit, may be routed through. Embodiments of the invention also provide hinges with low part counts, e.g. dual axis hinges with 8-10 parts. Embodiments of the invention provide rotational feel characteristics of a high quality, are capable of providing forces about both axis of rotation to meet standards of devices such as cellular handsets, and include assemblies that will stand up to the demanding environment of a handheld device hinge.

### BRIEF DESCRIPTION OF THE DRAWINGS

FIG. 1A is an exploded view of a preferred embodiment hinge of the invention;

FIG. 1B is a partial assembled view of the FIG. 1A hinge illustrating y-axis stop features of the hinge;

FIG. 2 is a front perspective view the FIG. 1A hinge in a handheld device;

FIG. 3 is an assembled side perspective view of the FIG. 1A hinge;

FIG. 4 is an exploded perspective view of the y-axis subassembly of the FIG. 1A hinge;

FIG. 5 is a schematic diagram illustrating a method for assembling the FIG. 1A hinge into a handheld device;

FIG. 6 is an exploded perspective view of a hinge according to a second preferred embodiment of the invention;

FIG. 7 is an assembled side perspective view of the FIG. 6 hinge;

FIG. 8 is an exploded perspective view of a hinge according to third preferred embodiment of the invention;

FIG. 9 is a partial exploded top view of the FIG. 8 hinge;

FIG. 10 is an exploded view of a fourth preferred embodiment hinge of the invention;

FIG. 11 is an assembled perspective view of the FIG. 10 hinge;

FIG. 12 is an exploded view of the y-axis subassembly of the FIG. 10 hinge;

FIG. 13 is an exploded view illustrating assembly of the FIG. 10 hinge into a handheld device;

FIG. 14 is a partial front perspective view of a handheld device assembled with the FIG. 1 hinge;

FIG. 15 is a bottom perspective view of an anchor member of the hinge of FIG. 1;

FIG. 16 is an exploded perspective view of fifth preferred embodiment hinge of the invention;

FIG. 17 is a partial perspective view that illustrates the hinge body of FIG. 16 hinge;

FIG. 18 is an exploded view of the y-axis subassembly of the FIG. 16 hinge; and

FIG. 19 is an assembled front perspective view of the FIG. 16 hinge.

### DETAILED DESCRIPTION

The invention provides a dual axis hinge for handheld devices. A preferred embodiment is a self-contained hinge that provides controlled rotation about two axes, which will be referred to in the description as x- and y-axes. Controlled rotation about an x-axis includes fully open and closed biased positions, and also preferably provides self-open and/or self-close assistance when predetermined rotational points about the x-axis are reached. Controlled rotation about a y-axis provides a bias position, e.g., 0°. Additionally, in the preferred embodiment both negative and positive rotation about the y-axis are permitted, and hard stops are defined at limits of negative and positive rotation.

In a preferred embodiment hinge, a unitary main body supports x-axis and y-axis rotational control sub-assemblies. The main body is preferably substantially hollow, with bores that provide a path through which wiring, e.g., flex circuit, may be routed through. Embodiments of the invention also provide hinges with low part counts, e.g. dual axis hinges with 8-10 parts. Embodiments of the invention provide rotational feel characteristics of a high quality, are capable of providing forces about both axis of rotation to meet standards of devices such as cellular handsets, and include assemblies that will stand up to the demanding environment of a handheld device hinge.

Embodiments also include a flip-style device having a hinged connection that includes a hinge having an x-axis and a y-axis, wherein the x-axis promotes movement of the flip and main parts into fully opened and fully closed positions, and the y-axis of the hinge provides a mechanism for the rotation of the flip part and main part relative to one another. Another embodiment includes a dual axis hinge for a handheld device that includes a circuit pass through. In the circuit pass through, for example, flex wire connections may be passed through the active elements of the hinge without interfering with hinge operation and allowing the flex circuit element to remain intact during operation of the hinge.

The invention also concerns handheld devices, such as handsets and personal digital assistants, including a dual axis hinged connection and having wiring that passes directly through the hinged connection. In preferred embodiments of the invention, a flex circuit connection provides a large number of data channels to connect electronics in the flip part and the main part. The number of communication channels provides the ability to conduct complex communications and move additional electronics into the flip part of the handheld device. In an embodiment of the invention, a handheld device includes a flex circuit connector that passes through a dual axis hinge in accordance with principles of the invention.

Some preferred embodiments of the invention will now be discussed with reference to the figures. Artisans will appreciate that some of the figures are presented schematically and are not necessarily to scale. Features may be exaggerated for the purposes of illustration.

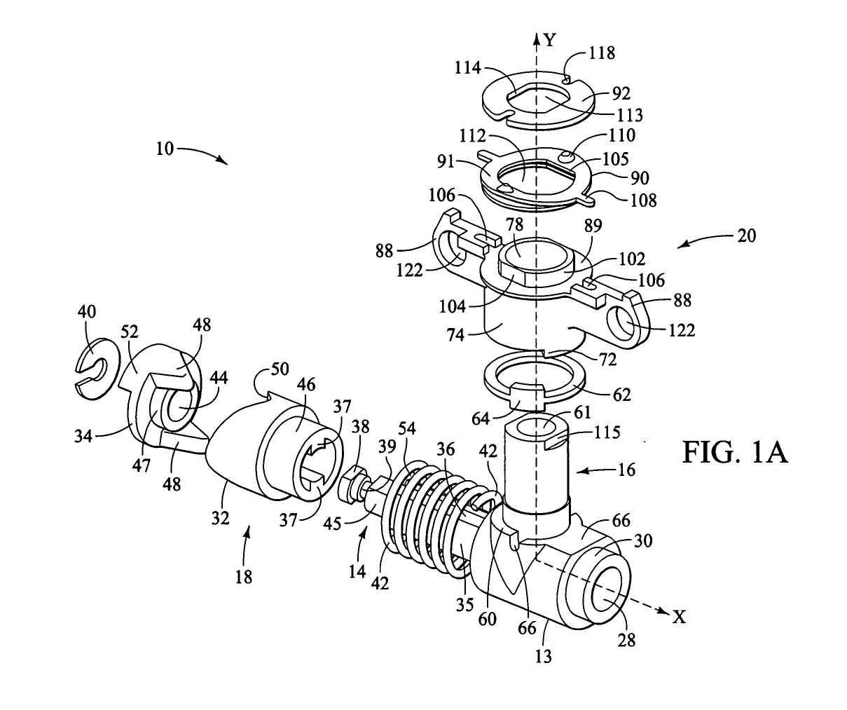

Referring now to FIG. 1A, a hinge 10 according to an embodiment of the invention is illustrated. The hinge 10 preferably includes a body 13, which is preferably at least partially hollow and unitary. The body 13 in the FIG. 1A embodiment is a unitary structure that defines an x-axis extension 14 coincident with x-axis of the hinge, and a y-axis extension 16 coincident with a y-axis of the hinge. An x-axis subassembly, indicated generally at 18, and a y-axis subassembly, indicated generally at 20, are provided to engage the respective x-axis extension 14 and y-axis extension 16 and control rotation about the x-axis and the y-axis of device parts that are respectively engaged to the rotational components of the x-axis and y-axis sub assemblies 18 and 20.

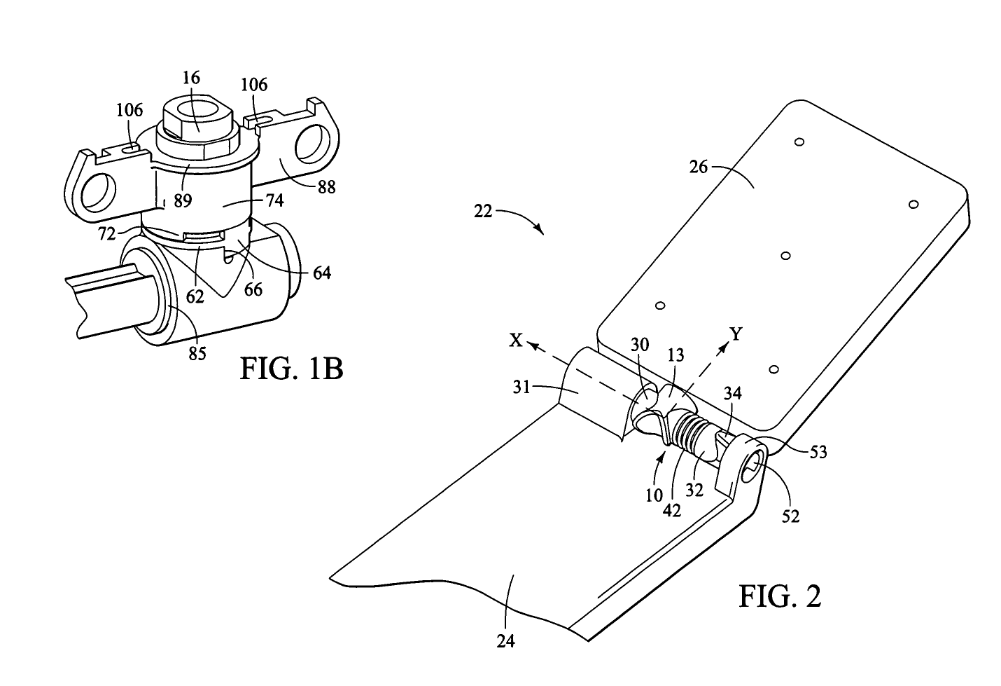

Basic x-axis and y-axis rotational movements can be appreciated with respect to FIG. 2, which shows an exemplary handheld device 22, for example a personal digital assistant (PDA) or a cellular handset. The handheld device 22 includes a main part 24 and a flip part 26. The flip part 26 may be opened by a user about the x-axis defined by the hinge 10. The hinge 10 provides initial resistance to opening about the x-axis, being in a biased closed position, and then provides opening assistance about the x-axis once a predetermined angle of rotation about the x-axis is reached. Once the flip part 26 is in a position that permits rotation about the y-axis, i.e., a position where such rotation will not be physically interfered with by the main part 24, the y-axis sub assembly 20 controls the rotation of the flip part 20, providing some rotational resistance and feel, and also providing stop positions. In a preferred embodiment according to FIG. 1A, the hinge provides a bias position of 0° about the y-axis, and permits both negative and positive rotational movements about the y-axis, with positive and negative hard stops, preferably at +180° and −180° rotation about the y-axis.

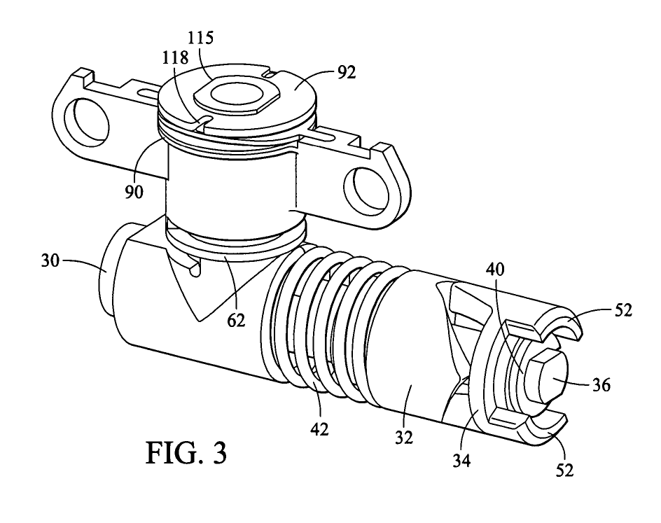

With reference to FIGS. 1A through 4, the body 13 defines an axial bore 28 extending into the body 13. An annular seat 30 is accommodated rotationally, for example, within a knuckle 31 of the main part 24 of the handset 22. The x-axis extension 14 is sized and configured to engage a cam 32. This engagement fixes the relative rotational position of the housing 13 and the cam 32 so that the cam may, along with a follower 34 control rotation of the hinge 10 about the x-axis.

In the preferred embodiment, the x-axis extension includes arcuate flanges 35 and flats 36 to slidingly engage guides 37 formed within the cam 32. An end 38 of the x-axis extension 14 defines an annular groove 39 that mates with a locking clip 40 to hold the x-axis subassembly 18 together, as a spring 42 urges the cam 32 against the follower 34 held in place axially by the locking clip 40. The follower 34 includes a hole 44 that rotates on arcuate surfaces 45 of an end of the x-axis extension 14. When assembled, the locking clip 40 (along with a device part knuckle) will hold the follower 34 in abutment against the ends of the arcuate flanges 35 to fix the axial position of the follower 34. A seat 46 of the cam 32 seats the spring 42. Ridges 48 on the follower are contoured to ride along a cam surface 50 defined on the cam 32. As artisans will appreciate, the shape and size of the ridges 48 and the depth and profile of the contours on the cam surface 50 may be designed to provide particular feel, the open and closed bias positions, as well as the points at which self-open and self-closed assistance may begin. The backside of the follower 34 defines a device interface 52 that locks into a knuckle 53 of the main part 24 to fix the relative rotational position of the main part 24 and the follower 34. Additionally, the device interface 52 can radially bound the locking clip 40.

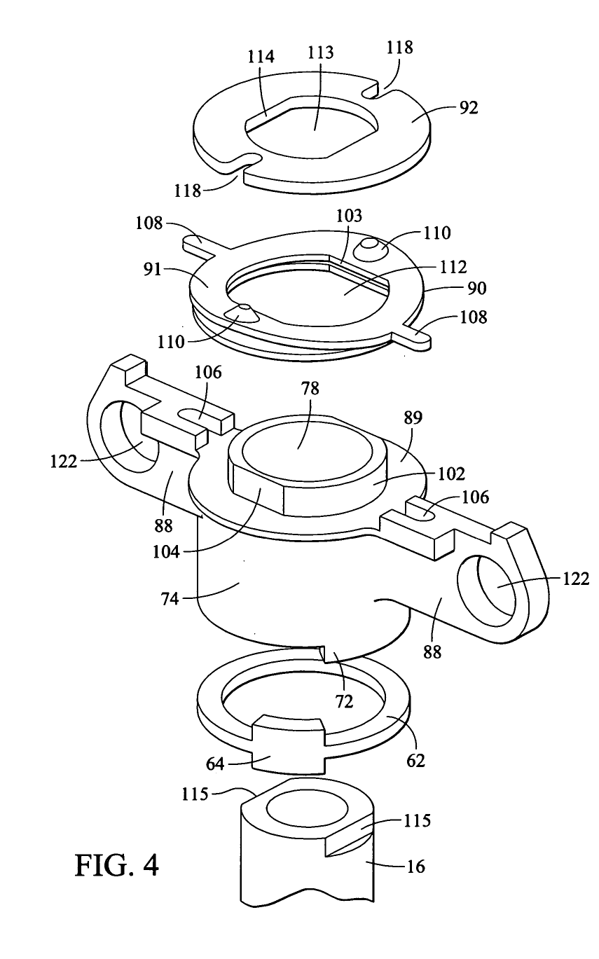

The y-axis subassembly 20 is configured to control a predetermined range of rotation in both positive and negative directions. For example, the y-axis subassembly provide a bias positions at 0°, and provide positive and negative rotation with hard stops at 180° and −180°. With reference primarily to FIGS. 1A and 4, a seat 60 is defined by the body 13 at the base of the y-axis extension 16. The seat 60 seats a stop collar 62, which has a stop 64 that meets a stop 66 of the seat 60. It is otherwise free to rotate on the seat 60. The stop 64 and stop 66 can meet in either of the clockwise and counterclockwise rotational directions about the y-axis.

The extension preferably includes a bore 61. A circuit pass through is defined, for example by a path through the bore 61 and the bore 28. The stop 64 also engages a stop 72 of a rotating device interface 74. The rotating device interface 74 seats on the stop collar 62 and includes a bore 78 to permit rotation about the y-axis extension 16.

FIG. 1B is partial view the FIG. 1A hinge, illustrating cooperation of the stop features shown in FIG. 1A. The stop collar 62 will rotate with the rotating device interface 74 in either the clockwise or counterclockwise direction when the stops 64 and 72 are engaged, and the limit of rotation in either direction is defined by the stop 66 (which extends around to the backside of the view shown in FIG. 1B). With reference to FIG. 1B, the stop 64 is shown in a position against the stop 66 that resulted from the full clockwise rotation of the rotating device interface 74. When the rotating device interface moved counter clockwise away from that position, the stop 64 likely remains in that position (though it is not harmful to device operation if it moves, due to friction, with the rotating device interface) until the counter clockwise rotation causes the stop 72 to engage the opposite side of the stop 64. Once engaged, counterclockwise rotation is permitted until the stop 72 rotates the stop 64 into the other side of the stop 66. The size and relative positions of the stops will determine the positive and negative rotation limits about the y-axis. In addition, FIG. 1B shows an additional seat 85 that serves to seat one end of the spring 42.

The rotating device member 74 includes radial arms 88 shaped to engage a device part, e.g., the flip part 26. In general, diametrically opposed pairs of radial arms are preferred, while a single rigid arm or other structure could be used to interface with a device part. Artisans will appreciate the additional rigidity and likely longevity provided by the preferred symmetrical and diametrically opposed radial arms 88. This is also true of other pairs of structures in the preferred embodiments that could alternatively perform the same functions without pairs, as artisans will appreciate. A top surface 89 of the device member forms a seat for a leaf spring biasing member 90, and a top surface 91 of the biasing member in turn forms a seat for a clip 92.

An axial collar 102 and the seat 89 seat the leaf spring biasing member 90, and the axial collar 102 also includes at least one and preferably two flats 104 to rotationally fix the clip 92 by engaging corresponding flats 105. A top surface of each of the radial arms 88 includes generally rectangular recesses 106. A pair of generally rectangular tabs 108 extend radially outwardly from the biasing member 90 and are accommodated by the recesses 106, and are preferably diametrically opposed to one another.

A pair of diametrically opposed, raised bumps 110 extend upwardly from the top surface of the biasing member 90. A central opening 112 of the leaf spring 20 fits snugly about the axial collar 102. A central opening 113 of the clip 92 includes flats 114 that engage flats 115 defined on the end of the x-axis extension 16. The central opening 113 of the clip 92 fits snugly over the top of the y-axis extension 16. A pair of circumferential notches 118 receive the raised bumps 110 of the biasing member 90 to define a bias position of the y-axis rotation of the rotating device interface 74, e.g., at 0°. The bumps 110 and leaf spring 118 also provide frictional rotational resistance when the rotation of the rotating device interface moves the raised bumps out of the notches 118. Artisans will, of course, understand that additional bias positions may be provided at arbitrary positions of y-axis rotation, and that the positions for positive and negative hard stops may also be altered. For example, additional notches 118 could provide additional positive and negative bias positions, which might also be called soft stop positions.

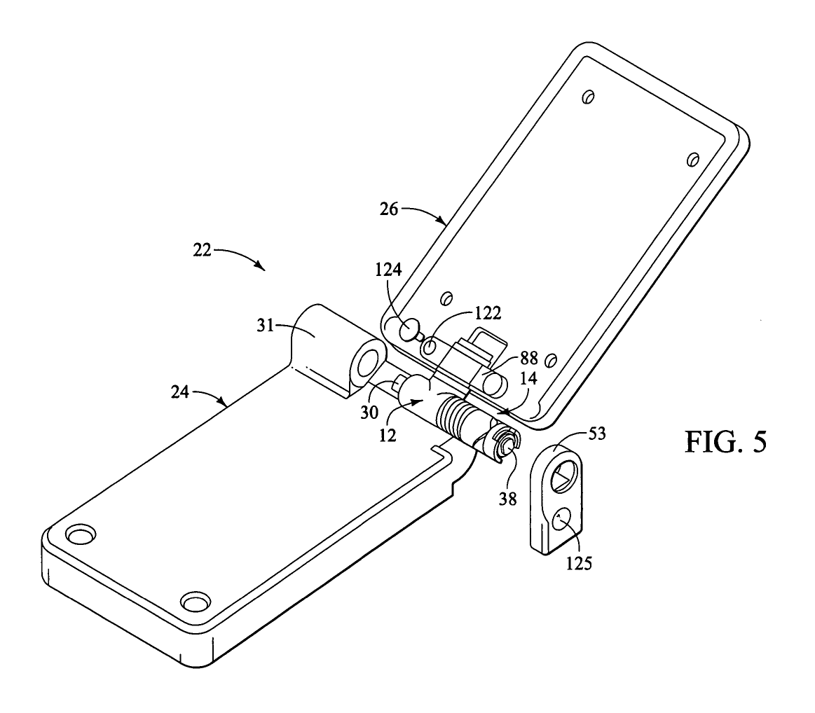

The rotating device interface 74 is fixed to rotate with a device part that is not attached to the follower 34, e.g., the flip part 26, through screws or rivets, for example, through mounting holes 122 of the radial arms 88. FIG. 5 shows an example where a fastener 124 may be used through mounting holes 122 to fasten the rotating device interface 74 to the flip part 26 thereby fixing the y-axis rotational position of the flip part 26 to that of the rotating device interface. The interface between the locking clip 92 and the leaf spring 90 provide rotational resistance, and a bias position about the y-axis when the bumps 110 engage the notches 118. Sufficient rotational force applied to the flip part 26 will move the bumps 110 out of the notches 118 to begin rotation. The rotating device interface 74 rotates with the leaf spring and the flip part 26 while the clip 92 is held rotationally in place relative to the y-axis extension 16 by the flats 114 and 115. This may be by an interference fit between the central opening 113 and the top of the x-axis extension 16, including the flats 115. The self-contained hinge may be first attached to the flip part 26, for example, and then attached to the main part 24. In an example, the knuckle 53 is attached by a fastener 125 after the rotating device interface 74 has been attached to the flip part 26.

Artisans will appreciate the self-contained nature of the FIGS. 1A-5 hinge. In addition to the general operational and structural advantages, a low part count can be considered an important feature. The hinge 10 includes a total of 9 parts.

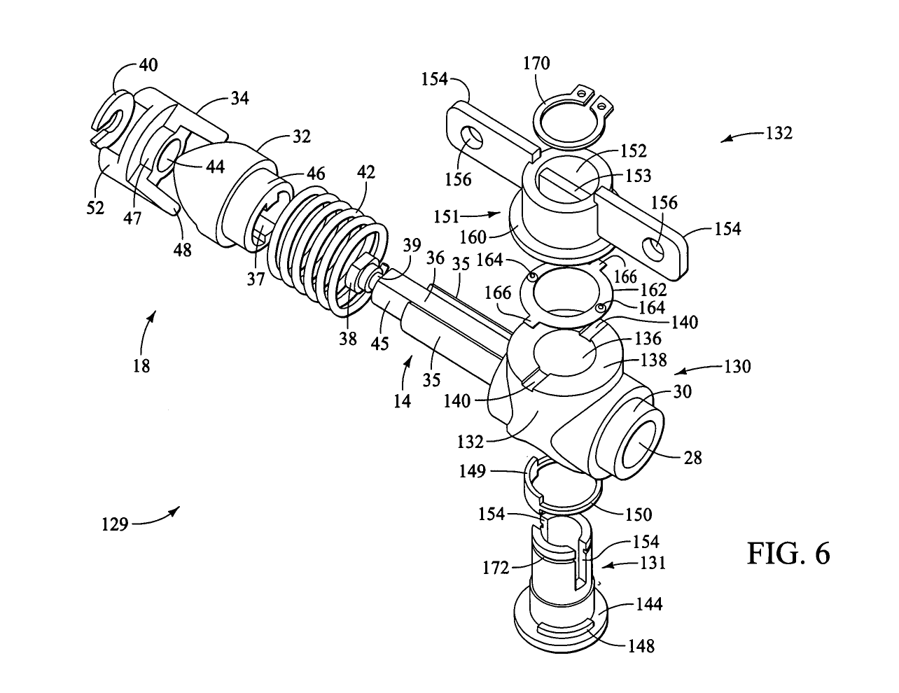

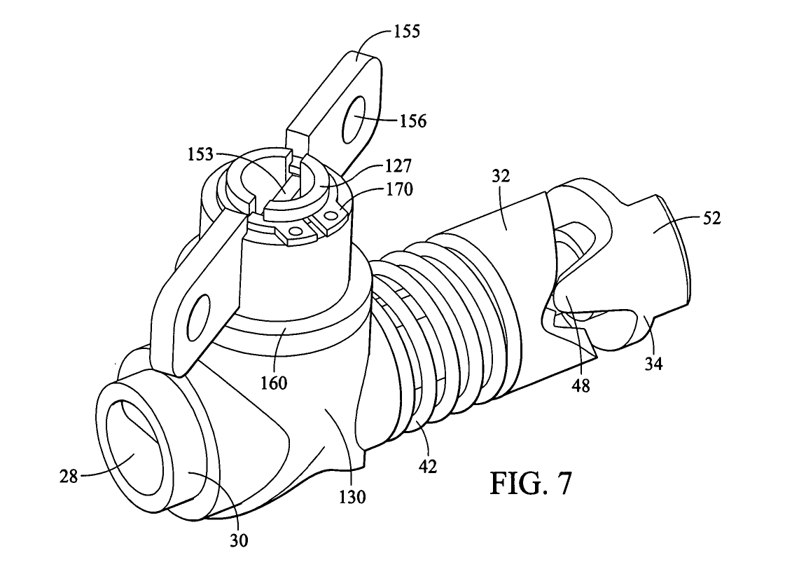

FIGS. 6-7 illustrate another embodiment hinge 129 with a modified hinge body 130 and y-axis subassembly 132. The embodiment of FIGS. 6-8 provides the same type of operation as the hinge of FIGS. 1-5 and may, for example, provide a 0° bias position for y-axis rotation, and hard stops at +180° and −180°. The x-axis is the same as in the FIGS. 1A-5 embodiment and the hinge 129 is labeled with like reference numbers for like parts.

As illustrated in FIG. 6, the hinge body 130 includes the x-axis extension 14 and x-axis subassembly 18 of the first embodiment. A y-axis extension in this embodiment is formed by a separate shaft 131 and an extended sleeve 132 that accepts the shaft 131 in its extended axial bore 136. A seat 138 is formed by the top surface extended sleeve 128, and includes a pair of diametrically opposed, generally rectangular recesses 140 disposed therein.

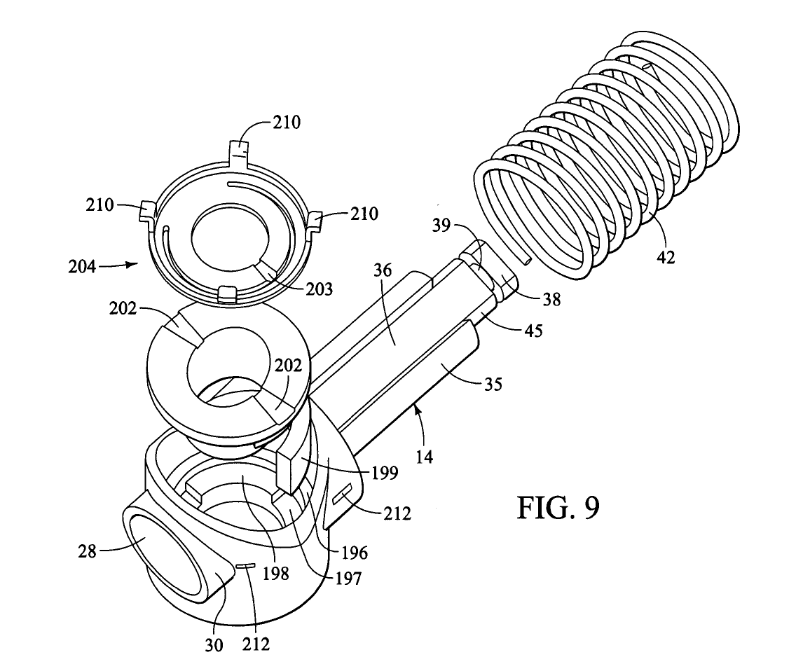

The y-axis extension shaft 131 defines a lower annular seat 144 and a stop 148 having a predetermined arc length, such as 90°. The stop 148 cooperates with a stop 149 on a stop collar 150, which is otherwise free to rotate relative to the seat 144. An internal fixed feature (not shown in FIGS. 6 and 7) of the bore 136 at the lower part of the body 136 defines a stop that interfaces with the stop 149 of the stop collar 150 to limit its rotation. A comparable feature is illustrated in FIG. 9, where the stop 198 is an internal fixed feature. A rotating device interface 151 has central cavity 152 and a bar 153 that engages slots 154 to fix the relative rotational position of the rotating device interface 151 and the 131.

During y-axis rotation in one direction, the bar 153 will eventually cause the stop 148 to push the stop 149 to its rotational limit where it engages an internal fixed feature of the body 130. When rotation is reversed, the bar will eventually cause the stop 148 to push stop 149 from an opposite side and push it into the opposite side of the internal fixed feature. In this manner, a negative and positive rotational stop may be defined, for example of +/−180°.

Diametrically opposed radial arms 154 each include a mounting hole 156 that accepts a fastener for attaching to a flip part 26 as in the FIGS. 1A-5 embodiment. An annular flange 160 includes an underside with a pair of diametrically opposed notches (not shown) to cooperate with a leaf spring biasing member 162, which has bumps 164. The bumps 164 along with the notches in the underside of the flange 160 provide a bias position, e.g., 0°, for the rotating device interface in a like manner to the bumps 110 and notches 118 of the FIGS. 1A-5 embodiment. Tabs 166 extend radially from the apexes of the biasing member 162, and are configured to be held within the recesses 140 to fix the rotational position of the leaf spring 162. A locking clip 170 locks into an annular groove 172 of the shaft 131 to hold the y-axis assembly together.

Artisans will appreciate the self-contained nature of the FIGS. 6-7 hinge. In addition to the general operational and structural advantages, a low part count can be considered an important feature. The hinge 129 includes a total of 10 parts.

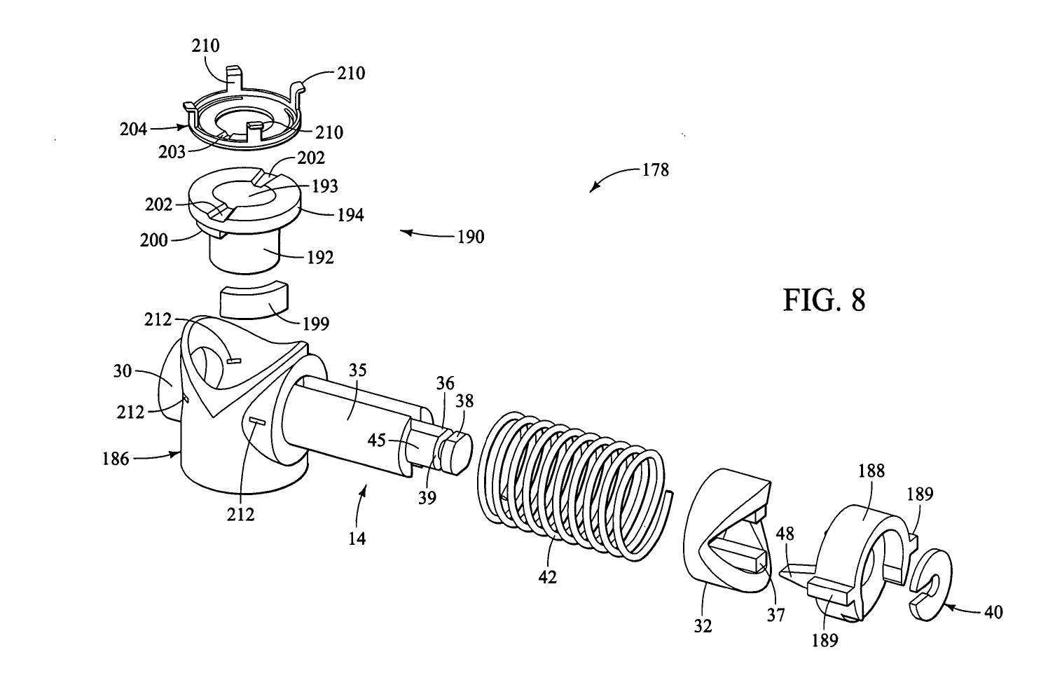

FIGS. 8-9 illustrate another preferred embodiment hinge 178. The hinge includes a body 186. The x-axis subassembly is similar to the previous embodiments, but includes a modified follower 188 that defines a radially extending device interface 189 that rotationally fixes the follower, for example, in a knuckle of the main part 24 of the handheld device. Remaining parts of the x-axis assembly have been labeled with the reference numbers used in the previous embodiments. A y-axis subassembly 190 is different than in the other embodiments, but provides similar controlled rotation about the y-axis.

The y-axis subassembly 190 includes a rotating device interface 192 that will rotate about the y-axis with the flip part of a handheld device. The rotational position of the rotating device interface 192 is fixed relative to a device part, e.g., the flip part 26, by internal features in a bore 193. For example, the bore 193 has an elliptical shape so that a matched shaft formed on a flip part may be inserted a distance into the bore and be rotationally fixed relative to the rotating device interface 192.

An annular seat 194 on the rotating device interface 192 seats on an upper seat 196 in the main body 186. A lower seat 197 includes a stop 198. An arcuate stop collar 199 (which is not a full ring, though a stop collar similar to the first two embodiments could also be used) rests on the lower seat 197 and is rotated by a stop 200 on the bottom of the seat 194. The heights of the stop 200, the stop 198 and the distance between the seat 196 and the seat 197 permits the stop 200 to clear the stop 198. In this way, the stop 200 does not directly contact the stop 198. A stop is instead realized when the stop 200 pushes the arcuate stop collar 199 up against either side of the stop 198.

In this manner. for example, the stops may be created at +/−180°, for example, or at other predetermined negative and positive rotation limits. An upper surface of the seat 194 includes two notches 202. These notches cooperate with a bump 203 on the underside of a leaf spring biasing member 204 to control the rotation in the y-axis of the rotating device interface 194. The biasing member 204 is held in the main body 186 by teeth 210 that engage corresponding slots 212.

Artisans will appreciate the self-contained nature of the FIGS. 8-9 hinge. In addition to the general operational and structural advantages, a low part count can be considered an important feature. The hinge 178 includes a total of 8 parts.

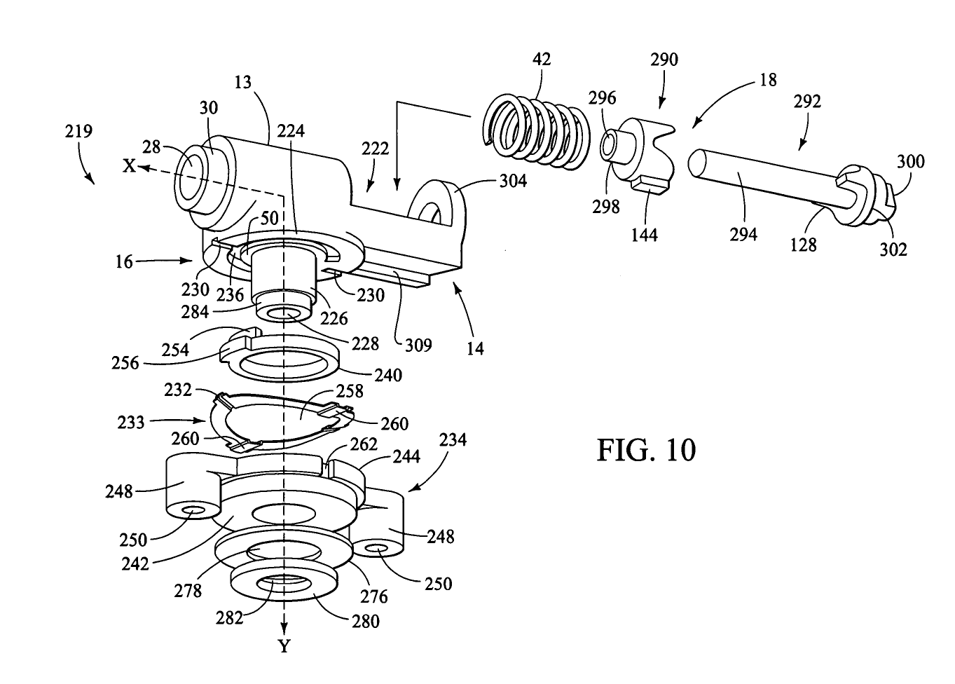

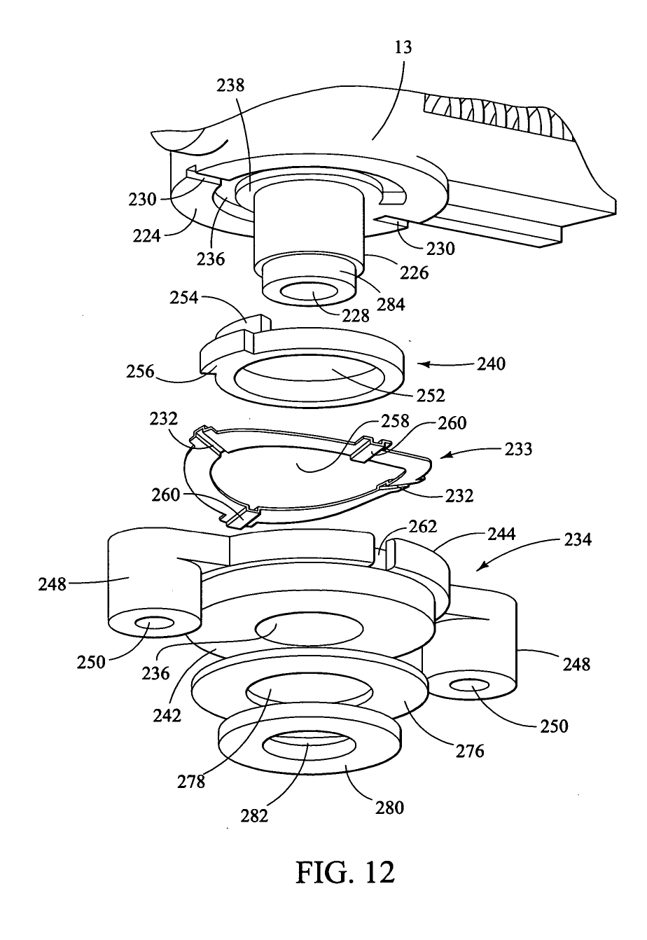

Referring now to FIGS. 10-15, a hinge 219 according to a fourth preferred embodiment is shown. The hinge 219 preferably includes a main hinge body 13, which is generally hollow. Similar parts are labeled with like reference numbers to the FIG. 1A-5 hinge.

The x-axis extension 14 of the hinge 219 defines an elongated cavity 222. The hinge body 13 is a unitary structure, as in FIG. 1A, which defines the y-axis extension 16. At the base of the y-axis extension is seat 224 for seating the y-axis subassembly about a shaft 226 having an axial bore 228 that is preferably continuous with the axial bore 28, which provides a path for a circuit pass between device parts, such as the main part 24 and the flip part 26 of FIG. 5.

The seat 224 extends a distance away from the remainder of the body 13 such that parts of the y-axis subassembly that rotate on the seat 224 are clear from interference with the remaining portions of the main body 13. Two diametrically opposed recesses 230 in the seat 224 cooperate with tabs 232 on a fix the position of the leaf spring biasing member 233 and define a bias position, e.g., 0° for a rotating device interface 234.

An arcuate opening 236 spans less than 360° to define a rotation stop in the seat 224. The seat includes an inner portion 238 defining a shelf to support a stop collar 240. The rotating device interface 234 includes a generally ring-shaped body having a generally planar bottom surface 242 and a receiving surface 244 opposite the bottom surface, with a generally cylindrical central opening 236. Diametrically opposed radial arms 248 having holes 250 for fasteners to attach to a device part. The receiving surface 244 of the rotating device interface 234 is configured to receive both the leaf spring biasing member 233 and the stop collar 240.

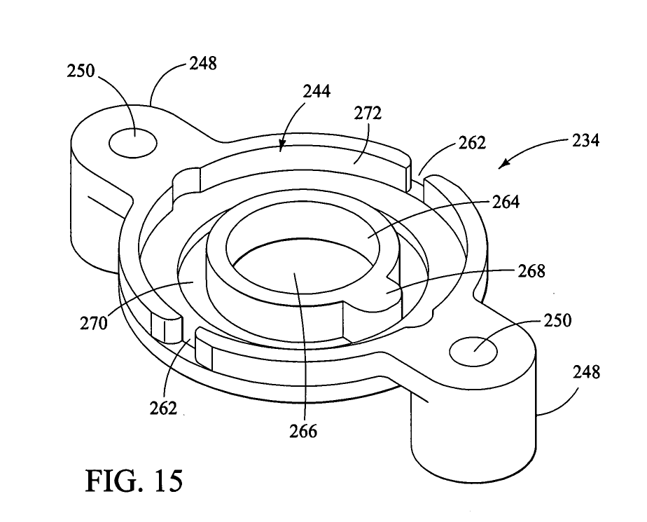

The stop collar 240 also has a central opening 252 to fit around the shaft 226, an arcuate axial stop 254 extending upwardly from a top surface of its circumference, as well as an arcuate radial stop 256 that extends outwardly from its external circumference. The axial stop 254 cooperates with the arcuate opening 236, while the radial stop 256 cooperates with features in the receiving surface 244 (see, e.g., FIG. 15).

The biasing member 233 provides rotational resistance to control y-axis rotation, and includes a central hole 258 and the tabs 232, which engage the recesses 230 to fix the relative rotational position of the biasing member 233 and the seat 224. Bumps 260 are configured to mate with diametrically opposed notches 262.

The receiving surface 244 is illustrated FIG. 15. The diametrically notches 262 are disposed at an outer edge of the receiving surface 244. An axial sleeve 264 has a central bore 266. An arcuate stop 268 is configured to interface with the radial stop 256 of the stop collar 240. An annular channel 270 surrounds an outer circumference of the sleeve 264 and accommodates the stop collar 240 to permit the arcuate stop 268 and the radial stop 256 to engage when the stop collar is rotated relative to the rotating device interface. A circumferential wall 272 and seat 274 seat the rotating device member 234 on the seat 224 about the shaft 226 to permit relative rotational between the body 13 and the rotating device interface 234.

While elements the y-axis subassembly 20 may be engaged to one another via a plurality of mechanisms, including threaded engagement of one or more elements or via mounting with a nut assembly, the preferred embodiment of FIG. 10 lockingly engages elements of the y-axis subassembly via swaging. To this end, the preferred y-axis subassembly includes bearing member 276 having a central opening 278 and a swaging member 280 having a central opening 282.

Both the swaging member 280 and the bearing member 276 are generally planar, ring-shaped washer structures configured to engage the y-axis extension 16. The bearing member 276 is preferably composed of a relatively hard material, against which the rotating device interface 234 may rotate with minimum friction relative to the y-axis extension 16 (and hinge body 13). The bearing member 276 acts as a thrust bearing. The swaging member 280 is interference fit on a shaped end 284 of the y-axis extension 16, with the central opening 282 locking onto the shaped end 284.

As in the other embodiments, the various stops cooperate to provide a positive and negative limit of rotation. Rotation of the hinge body 13 with a device part, e.g., a flip part, is first inhibited at a 0° position by engagement of the bumps 260 and the notches 262 because the rotating device interface is fixed to a different device part. When the notches are overcome, the body 13 rotates. At some point, the stop in the arcuate opening 236 will push against the axial stop 254 to begin rotation of the stop collar 240. The rotation is then permitted until the radial stop 256 of the stop collar 240 meets the arcuate stop 268 of the rotating device member 234. While ranges of rotation may vary to suit individual applications, the preferred embodiment provides positive and negative hard stop limits at +/−180° positions, for example.

Rotation is also controlled about the x-axis by a cam and follower arrangement as in the other embodiments. The cam and follower are, in the hinge 219, accommodated within the cavity 222 instead of about flanges and a shaft as in the previous embodiments. Specifically, a cam 290 cooperates with a follower 292. The follower 292 includes a shaft 294 rotationally supports the cam 290 through its hole 296. A seat 298 about the hole 296 seats the spring 42. A device interface 300 is formed at an end of the follower. When assembled, the shaft 294 has its end rotational held at one end of the cavity 222 (for example in the bore 28) and a flange 302 is pressed against an end 304 of the x-axis extension, which has a hole 306 smaller than the flange 302 but large enough to permit the device interface 300 to extend therethrough. The cam 290 has its rotational position fixed relative to the body 13 by an extension 308 that engages a channel 310 (the underside of which is visible in FIG. 10) in the cavity 222. The extension 308 and channel 309 permit the cam 290 to have an axial range of movement sufficient to permit cam/follower operation.

The interaction between the cam 290 and cam follower 292 provide rotational control and feel, and provide discrete bias positions defining fully opened and fully closed positions and self-open and self-close capability as in the other embodiments. The follower 292 rotates about the x-axis with one device part, e.g., the flip part 26, and the hinge body 13 with the other part, e.g., the main part 24.

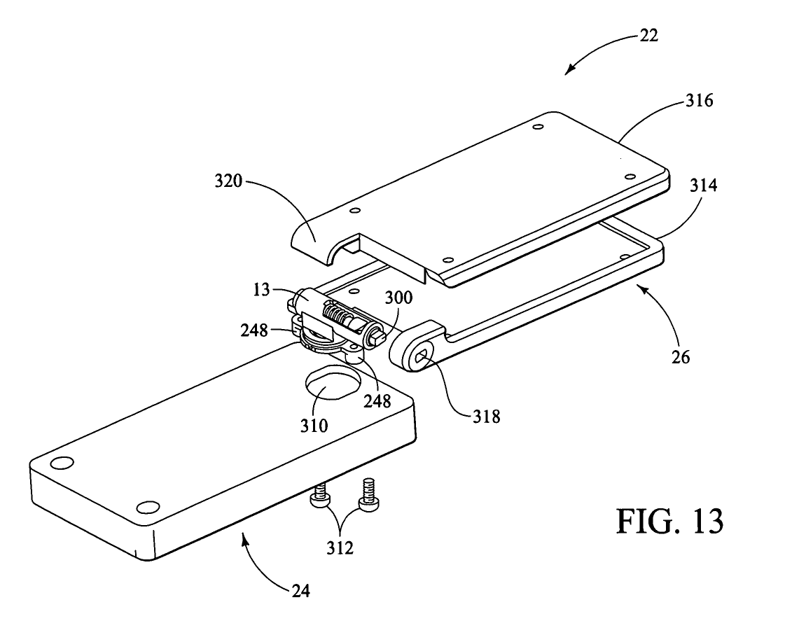

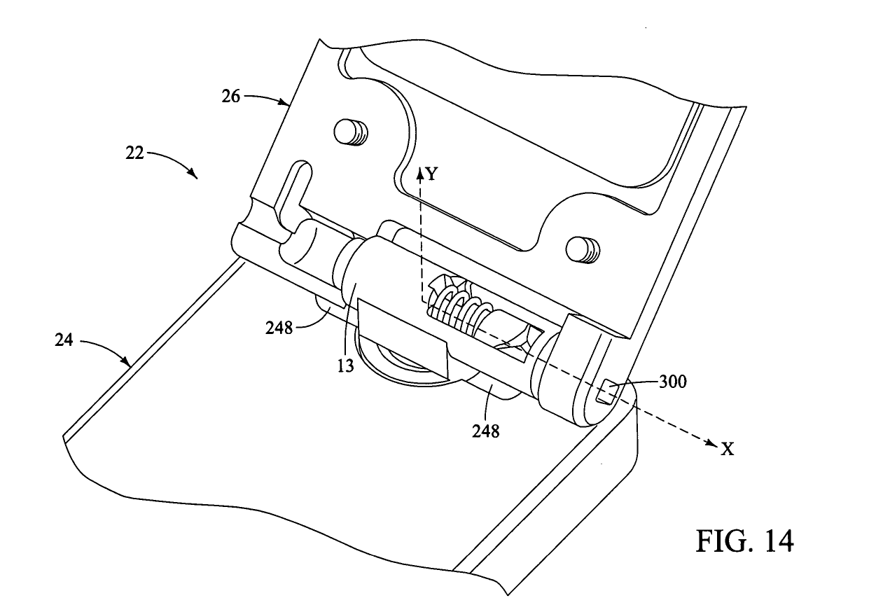

FIGS. 13 and 14 illustrate an exemplary installation of the hinge 219 in a handheld device 22. In FIGS. 13 and 14, the flip part 26 rotates with the follower 292 and relative to the main body 13 during x-axis rotation. The flip part 26 rotates with the main body 13 and relative to the rotating device interface 234 during y-axis rotation. The opposite is true for x-axis and y-axis rotation of the main part 24.

The main part 24 can include, for example, a recess 310 to accommodate the rotating device interface 234. A pair of fasteners 312, such as threaded fasteners to attach to the holes 250 in the radial arms through an underside of the main part 24. The seat 224 is generally coplanar with a top surface of the main part 24 to avoid rotational interference of the remainder of the body 13 with the main part 24 during y-axis rotation.

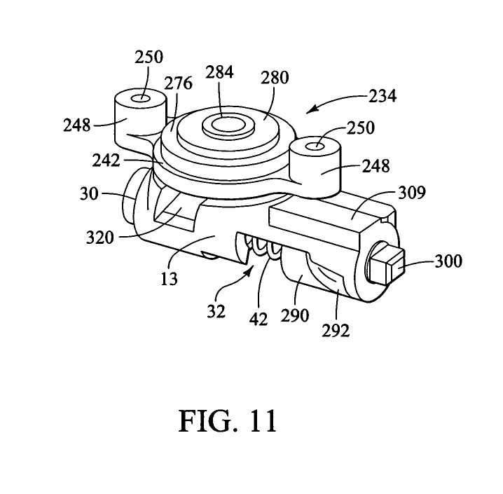

The flip part 26 can include base and cover parts 314 and 316. The base part 314 includes a knuckle that is configured to engage the device interface 300, while the cover part preferably includes a shaped extension 320 that is shaped to engage the irregular shape of the hinge body 13. For example, the hinge body can define a shelf 320 (see FIG. 11) that mates with the shaped extension 320. In addition, the general irregular shape of the hinge body 13 permits fixation of the hinge body 13 relative to the flip part 26.

The main hinge body 13 in preferred embodiments is generally hollow, with at least a portion of the axial bore 28 remaining unobstructed. Additionally, the bore 228 of the y-axis extension is at least partially hollow. Accordingly, as in other embodiments, the hinge 219 provides a path through which circuitry and other electronics may be wired. Advantageously, wiring may be installed during or immediately following assembly of the hinge device 10, which may then be provided as a self-contained unit. For example, flex wire connections may be passed through the active elements of the hinge without interfering with hinge operation and allowing the flex circuit element to remain intact during operation of the hinge. A flex circuit connection provides a large number of data channels to connect electronics in the flip part 26 and the main part 24. The number of communication channels provides the ability to conduct complex communications and move additional electronics into the flip part 24 of the handheld device 22.

Artisans will appreciate the self-contained nature of the FIGS. 10-15 hinge. In addition to the general operational and structural advantages, a low part count can be considered an important feature. The hinge 219 includes a total of 9 parts.

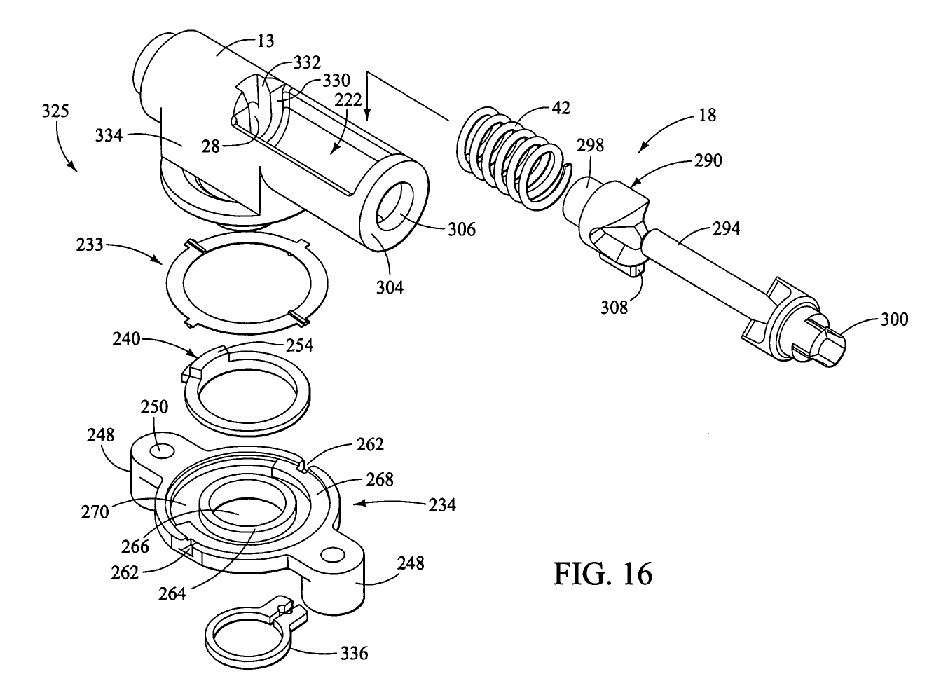

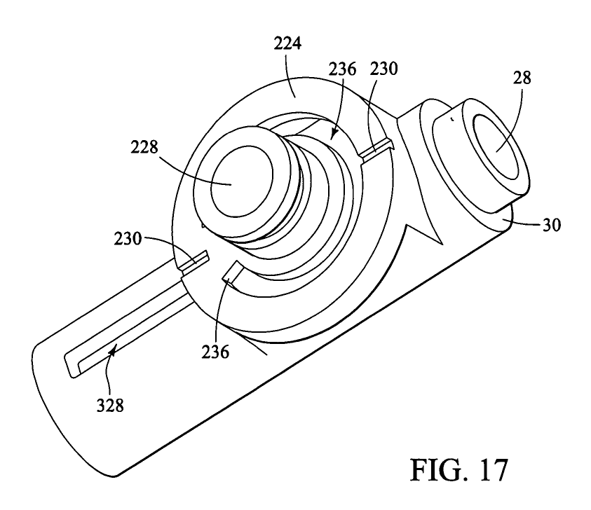

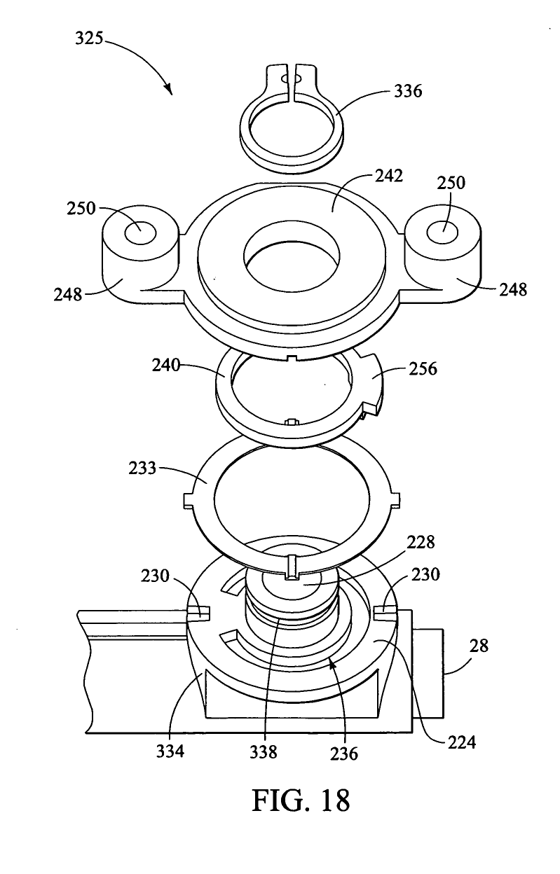

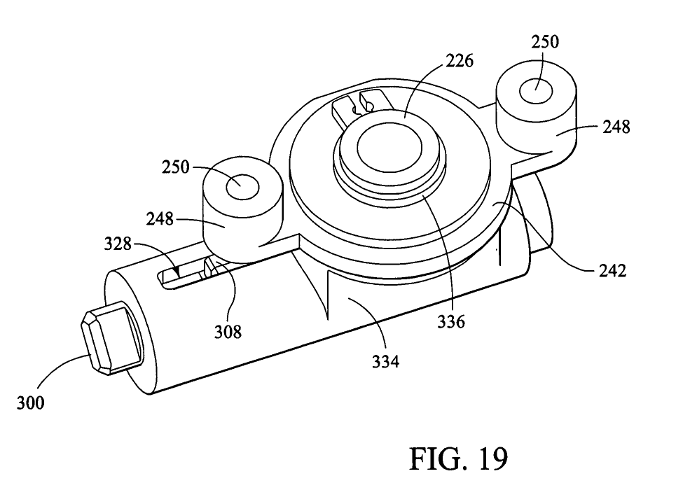

Turning now to FIGS. 16-19, a fifth preferred embodiment hinge 325 is illustrated. In the FIGS. 16-19 embodiment, the x-axis subassembly and extension are highly similar to the FIGS. 10-15 embodiment. Instead of the channel 309, the cavity 22 includes an open slot 328 to accommodate the extension 308 of the cam 290. The slot 328 permits axial movement of the cam 290 and fixes its rotational position relative to the body 13. FIG. 16 also illustrates the internal structure of the cavity 222, which excepting the slot 328, can be identical. A surface 330 provides resistance for compression of the spring 42 by the axial movement of the cam 290 caused by relative rotation of the cam and follower 292. A slot 332 aids assembly, allowing the shaft 294 to be guided in the bore 28 to fix the radial position of the cam, follower and spring. The hinge 325 also includes a modified y-axis subassembly compared to FIGS. 10-15. The body 13 has a more irregular shape, including a raised base 334 to interface with a device part and permit rotation of the body 13 to clear the device part to which the rotating device member is attached during y-axis rotation. A locking clip 336 replaces the swaging member of the FIGS. 10-15 embodiment. The clip 336 locks onto a channel 338 of the shaft 226.

Artisans will appreciate the self-contained nature of the FIGS. 16-19 hinge. In addition to the general operational and structural advantages, a low part count can be considered an important feature. The hinge 325 includes a total of 8 parts.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention.

1. A dual axis self-contained hinge for a handheld device having a main part and a flip part being rotatable relative to each other about a x-axis and a y-axis of the hinge, the hinge comprising:
a hinge body;
an x-axis extension extending from said hinge body;
a cam and follower axially urged together by a spring, said cam, follower and spring being supported by said x-axis extension;
a first device interface rotationally fixed relative to one of said cam and follower and rotationally free relative to said hinge body about the x-axis, the other of said cam and follower being rotationally fixed relative to said hinge body and rotationally free relative to said first device interface about the x-axis;
a y-axis extension extending from said hinge body;
a second device interface supported by said y-axis extension to be rotational relative to said hinge body about the y-axis;
a biasing member to bias rotational movement of said second device interface about the y-axis; and
hard stops about the y-axis to limit y-axis rotation of said second device interface relative to said hinge body about said y-axis.

2. The hinge of claim 1, wherein said first device interface comprises a portion of said follower, and said cam is rotationally fixed relative to said hinge body but permitted to travel axially relative to said hinge body.

3. The hinge of claim 2, wherein:
said x-axis extension comprises arcuate flanges, a flat, and arcuate surfaces;
said cam comprises a guide to mate with said flat and said flanges and fix said cam rotationally upon said x-axis extension and relative to said hinge body while permitting axial movement between said cam relative to said x-axis extension and said hinge body;
said follower comprises a hole that mates with said arcuate surfaces and abuts said arcuate flanges to permit rotation of said follower about said x-axis while holding said follower in a fixed axial position relative to said x-axis extension and said hinge body.

4. The hinge of claim 3, wherein said cam and said hinge body include seats to seat the axial spring between said cam and a portion of said hinge body.

5. The hinge of claim 4, further comprising a clip to hold said follower against said arcuate flanges.

6. The hinge of claim 2, wherein:
said x-axis extension comprises a cavity; and
said cam, said follower and said spring are held about a shaft in said cavity, said cavity compressing said spring to urge said cam and said follower together.

7. The hinge of claim 6, wherein said shaft is part of said follower, and an end of said shaft is held rotationally within said hinge body.

8. The hinge of claim 7, wherein an end of said x-axis extension includes a hole to accommodate said device interface therethrough.

9. The hinge of claim 1, wherein said x-axis extension axially fixes and permits rotation of one of said cam and said follower and rotationally fixes and permits axial movement of the other said cam and said follower.

10. The hinge of claim 1, comprising a total part count of 10 parts.

11. The hinge of claim 1, comprising a total part count of 9 parts.

12. The hinge of claim 1, comprising a total part count of 8 parts.

13. The hinge of claim 1, wherein said hard stops provide both a positive rotational limit and a negative rotational limit of y-axis rotation of said second device interface relative to said hinge body.

14. The hinge of claim 13 wherein said hard stops comprise:
a first stop fixed in position relative to said hinge body;
a second stop fixed in position relative to said second device interface; and
a third stop movable in both counterclockwise and clockwise directions by movement of said second stop relative to said first stop to abut said first stop and said second stop at the positive rotational limit and at the negative rotational limit.

15. The hinge of claim 13, wherein said hard stops comprise:
a first stop fixed in position relative to said hinge body;
a second stop on said second device interface; and
a stop collar to interface said first and second stops at the positive rotational limit and at the negative rotational limit.

16. The hinge of claim 1, wherein said x-axis extension engages said cam to fix its relative rotational position while permitting axial movement of said cam relative to said x-axis extension and said hinge body.

17. The hinge of claim 16, wherein said x-axis extension extends through said cam and said follower.

18. The hinge of claim 16, wherein said x-axis extension extends around said cam and said follower.

19. The hinge of claim 1, wherein said cam and said follower define open and close bias positions about said x-axis extension, and provide one or both of self open and self close assistance at a predetermined point of relative rotation.

20. The hinge of claim 19, wherein said biasing member defines a y-axis bias position of rotation of the second device interface relative to said hinge body.

21. The hinge of claim 19, wherein said hard stops provide both a positive rotational limit and a negative rotational limit of relative rotation between said second device interface and said hinge body.

22. The hinge of claim 21, wherein the bias position of rotation is 0°, the positive rotational limit is +180° and the positive rotational limit is −180°.

23. The hinge of claim 1, wherein said hinge body is a unitary structure defining both the x-axis and y-axis extension.

24. The hinge of claim 1, wherein said hinge body defines a path to accommodate wiring through said hinge body and said y-axis extension.

25. A dual axis self-contained hinge for a handheld device having a main part and a flip part being rotatable relative to each other about an x-axis and a y-axis of the hinge, the hinge comprising:
an x-axis device interface;
x-axis means for controlling relative rotation of said x-axis device interface about an x-axis;
an y-axis device interface;
y-axis means for controlling relative rotation of said y-axis device interface about a y-axis;
hinge body means for providing structural support said x-axis means and said y-axis means; and
stop means for providing a y-axis positive rotational limit and a y-axis negative rotational limit to stop rotation of said y-axis device interface relative said hinge body means at predetermined negative and positive angles of rotation.

26. The hinge of claim 25, comprising a total part count of 10 parts.

27. The hinge of claim 25, comprising a total part count of 9 parts.

28. The hinge of claim 25, comprising a total part count of 8 parts.

29. A dual axis self-contained hinge for a handheld device having a main part and a flip part being rotatable relative to each other about an x-axis and a y-axis of the hinge, the hinge comprising:
a hinge body supporting an x-axis subassembly and a y-axis subassembly;
a first device interface controlled to rotate relative to said hinge body about the x-axis by the x-axis subassembly, the x-axis subassembly providing bias positions of x-axis rotation and self-open and/or self close assistance at predetermined points of x-axis relative rotation of said first device interface and said hinge body; and
a second device interface controlled to rotate relative to said hinge body about the y-axis by the y-axis subassembly, the y-axis subassembly providing a bias position of rotation, a positive rotational limit, and a negative rotational limit.

30. The hinge of claim 29, wherein the bias position of rotation is 0°, the positive rotational limit is +180° and the positive rotational limit is −180°.

31. The hinge of claim 29, wherein said hinge body is a unitary structure defining that supports both the y-axis subassembly and the x-axis subassembly.

32. The hinge of claim 29, wherein said hinge body defines a path to accommodate wiring through said hinge body.

33. The hinge of claim 29, comprising a total part count of 10 parts.

34. The hinge of claim 29, comprising a total part count of 9 parts.

35. The hinge of claim 29, comprising a total part count of 8 parts.
